(19) United States
(12) Patent Application Publication
(10) Pub. No.: US 2004/0051622 A1
(43) Pub. Date: Mar. 18, 2004

(54) Polymeric PTC device and method of making such device

(75) Inventors: Ann Banich, Menlo Park, CA (US); Cecilia A. Walsh, Los Altos, CA (US)

Correspondence Address: TYCO ELECTRONICS CORPORATION, MAIL STOP R20/2B, 307 CONSTITUTION DRIVE, MENLO PARK, CA, 94025, US

(73) Assignee: Tyco Electronics Corporation, Middletown, PA

(21) Appl. No.: 10/655,919

(22) Filed: Sep. 5, 2003

Related U.S. Application Data
(60) Provisional application No. 60/411,481, filed on Sep. 17, 2002.

(51) Int. Cl. H01C 7/10

(52) U.S. Cl. 338/22 R

(57) ABSTRACT

A method for tuning a resistance v. temperature profile of a surface mountable polymeric PTC device for use as an overtemperature protection device. The method includes preparing a laminate comprising a conductive polymer composite sandwiched between metal foil electrodes; crosslinking the laminate; forming a panel from the crosslinked laminate by patterning the laminate to form a plurality of surface mountable devices; irradiating the panel using electron beam irradiation of at least 20 Mrad; and providing individual devices by subdividing the irradiated panel.

### CROSS-REFERENCE TO RELATED APPLICATIONS

This application claims the benefit of U.S. Provisional Application No. 60/411,481, filed Sep. 17, 2002, the disclosure of which is incorporated herein by reference.

### BACKGROUND OF THE INVENTION

1. Field of the Invention

This invention relates to a polymeric PTC device for use as an overtemperature device, and methods of making such a device.

2. Introduction to the Invention

Polymeric positive temperature coefficient (PTC) circuit protection devices (“PPTCs”) are typically produced from extruded conductive polymer sheet that has been laminated on both sides with a conductive metallic foil. Useful methods of producing a plurality of laminar surface mount polymeric PTC devices which have at least two electrical connections on one surface have been described in U.S. Pat. No. 5,852,397 (Chan et al.), U.S. Pat. No. 6,211,771 (Zhang et al.) and U.S. Pat. No. 6,292,088 (Zhang et al.), and U.S. patent application Ser. No. 09/395,869 (Hetherton et al., filed Sep. 14, 1999), the disclosures of which are incorporated herein by reference. These methods include the patterning of the laminates using printed circuit board technology to form a panel, and then isolating many single devices from the panel (i.e. singulation), for example by sawing, snapping or shearing.

In circuit protection devices, it is desirable for the PTC conductive polymer composite to be crosslinked, preferably by means of radiation. The effect of the crosslinking depends on the polymer and the conditions during the crosslinking step, as discussed in U.S. Pat. No. 4,845,838 (Jacobs et al.) and U.S. Pat. No. 4,857,880 (Au et al.), the disclosures of which are incorporated herein by reference. For example, it is known that a PTC conductive polymer can be crosslinked using high doses of irradiation, i.e. at least 50 Mrads, and that the resulting resistance v. temperature [R(T)] curve of the conductive polymer is changed so that a given resistance value is reached at a lower temperature than for an unirradiated device. It is also known that crosslinking a polymeric PTC composite material can be accomplished by irradiating the material using more than one irradiation step and including a heat treatment which exposes the material to temperatures above its melting point between the irradiation steps. The high irradiation doses and multiple irradiation steps have been found to be especially useful for increasing the performance of polymeric PTC devices under high voltage operation, i.e. at least 72 volts. For devices that are designed to operate below 72V the laminate is typically irradiated at lower levels, e.g. to 5 to 15 Mrads, prior to downstream processing (e.g., punching of chips from laminates or patterning of laminates to form panels for subdivision into multiple surface mount devices). This irradiation is typically conducted in a single step, with no intermediate thermal treatment.

Polymeric PTC devices are commonly used as overcurrent protection devices, and in some cases they are used as overtemperature or thermal cutoff protection devices. Typically, when a polymeric PTC device is used as an overtemperature protection device, it is normally in its low resistance state while the equipment with which it is in electrical contact is under normal operating conditions. As the PTC device heats up due to a heat source, its resistance will increase. As the temperature of the equipment, the environment surrounding the equipment, or a local environment within the equipment increases to a fault state, the resistance of the PTC device increases to a value which will provide a trigger for another part of the circuit to reduce power.

It is known that the switching temperature, Tₛ, of a polymeric PTC device can be changed by changing the polymer component of the polymeric composite, e.g. by making polymeric blends. See, for example, the compositions described in U.S. Pat. No. 5,451,919 (Chu et al.), U.S. Pat. No. 5,582,770 (Chu et al.), U.S. Pat. No. 5,801,612 (Chandler et al.), U.S. Pat. No. 6,362,721 (Chen et al.), and U.S. Pat. No. 6,358,438 (Isozaki et al.), the disclosure of which is incorporated herein by reference. However, generally when the polymeric component of the composite is changed, there may be significant changes in resistance/temperature profiles, in resistivity, and in the resistance at the switching temperature of the resulting devices. In addition, significant materials development effort may be required when the composite composition is changed because processing conditions must be changed or optimized when the polymer is changed or a new polymer blend is created. Manufacturing of a family of devices made from different composite materials can have increased costs and lead times for delivery because of the set-up time required for conversion of materials on mixing, extrusion and lamination procedures, and the increased inventory required for more starting materials and work-in-process.

### BRIEF SUMMARY OF THE INVENTION

It has been previously unknown that an additional high irradiation dose (for example, greater than 20 Mrads, preferably 50 to 100 Mrads) applied to finished panels (prior to singulation) or to finished laminar surface mount devices (as described for example in U.S. Pat. No. 5,852,397 or U.S. patent application Ser. No. 09/395,869) can be used to finely tune their R(T) curves to provide improved overtemperature protection devices. The additional beam dose can improve performance by producing increased resistance at a given temperature (e.g., at its switching temperature) or can lower the switching temperature in a controlled fashion while maintaining or increasing the resistance at or above the switching temperature without changing the formulation of the conductive polymer. For example, the switching temperature can be lowered in 3 to 4 degree Celsius steps using the method described herein. Preferably, the laminates have been crosslinked (preferably using irradiation) prior to being patterned to form panels and therefore prior to the formation of laminar surface mount devices, although it such crosslinking of the laminate is not necessary for some applications. Preferably, the additional beam dose is preceded by a heat treatment which will cause the polymeric composite material to be heated above its melt temperature. The method described herein can allow customized tailoring of the R(T) shape as required such that devices may be easily designed into various overtemperature protection applications, often without varying the PTC material or construction. For example, the same batch of finished laminar surface mount devices may be further processed according to the method described herein to produce several different surface mountable overtemperature protection devices.

In a first aspect this invention provides a method for tuning a resistance v. temperature profile of a surface mountable polymeric PTC device for use as an overtemperature protection device, said method comprising:

(a) preparing a laminate comprising a conductive polymer composite sandwiched between metal foil electrodes, said polymer composite having a melting temperature Tₘ;

(b) crosslinking the laminate;

(c) forming a panel from the crosslinked laminate by patterning the laminate to form a plurality of surface mountable devices;

(d) irradiating the panel using electron beam irradiation of at least 20 Mrad; and

(e) providing individual devices by subdividing the irradiated panel.

In a second aspect, this invention provides a method for tuning a resistance v. temperature profile of a polymeric PTC device for use as an overtemperature protection device, said method comprising:

(a) preparing a laminate comprising a conductive polymer composite sandwiched between metal foil electrodes, said polymer composite having a melting temperature Tₘ;

(b) crosslinking the laminate;

(c) forming individual devices from the crosslinked laminate; and

(d) irradiating the individual devices using electron beam irradiation of at least 20 Mrad.

### BRIEF DESCRIPTION OF THE DRAWINGS

The invention is illustrated by the accompanying drawings in which FIG. 1 shows a voltage divider circuit which can utilize a device made according to the method of the invention.

FIG. 2 shows resistance v. temperature curves for a set of polymeric PTC devices in which the switching temperature has been varied by changing the polymeric component.

FIG. 3 shows resistance v. temperature curves for a set of polymeric PTC devices in which R(T) characteristics have been varied using the method described herein.

### DETAILED DESCRIPTION OF THE INVENTION

Devices of the invention comprise at least one laminar polymer element or resistive element which comprises a PTC conductive polymer composition which exhibits positive temperature coefficient (PTC) behavior, i.e. it shows a sharp increase in resistivity with temperature over a relatively small temperature range. The term “PTC” is used to mean a composition or device that has an R₁₄ value of at least 2.5 and/or an R₁₀₀ value of at least 10, and it is preferred that the composition or device should have an R₃₀ value of at least 6, where R₁₄ is the ratio of the resistivities at the end and the beginning of a 14° C. range, R₁₀₀ is the ratio of the resistivities at the end and the beginning of a 100° C. range, and R₃₀ is the ratio of the resistivities at the end and the beginning of a 30° C. range.

Circuit protection devices and PTC conductive polymer compositions for use in them disclosed for example in U.S. Pat. No. 4,237,441 (van Konynenburg et al.), U.S. Pat. No. 4,304,987 (van Konynenburg), U.S. Pat. No. 4,514,620 (Cheng et al.), U.S. Pat. Nos. 4,534,889 (van Konynenburg et al.), U.S. Pat. No. 4,545,926 (Fouts et al.), U.S. Pat. No. 4,724,417 (Au et al.), U.S. Pat. No. 4,774,024 (Deep et al.), U.S. Pat. No. 4,935,156 (van Konynenburg et al.), U.S. Pat. No. 5,049,850 (Evans et al.), U.S. Pat. No. 5,378,407 (Chandler et al.), U.S. Pat. No. 5,451,919 (Chu et al.), U.S. Pat. No. 5,582,770 (Chu et al.), U.S. Pat. No. 5,747,147 (Wartenberg et al.), and U.S. Pat. No. 5,801,612 (Chandler et al.), and U.S. Pat. No. 6,358,438 (Isozaki et al.). The disclosure of each of these patents is incorporated herein by reference.

The PTC conductive polymer composition has a melting temperature, Tₘ, as measured by the peak of the endotherm of a differential scanning calorimeter. When there is more than one peak, Tₘ is defined as the temperature of the highest temperature peak.

For a simple overtemperature detection scheme, a PTC device can be used in a voltage divider circuit, for example as is shown in FIG. 1, wherein elements 1 and 2 are resistors, element 4 is a switching transistor (e.g., a MOSFET), element 5 is the source (e.g., a battery), and element 3 is a PTC device. As shown for example in FIG. 1, the PTC device is generally not a series element for this protection scheme, although there may be alternate circuits where it is a series element. In the low temperature state in which there is no overtemperature condition, the PTC device is in its low resistance state, and therefore little voltage is dropped across it. When the PTC device heats, the resistance increases so the voltage drop on the PTC increases (e.g., for the circuit shown in FIG. 1, as the resistance of the PTC approaches that of resistor 1, the voltage drop across the PTC element 3 becomes significant). At some temperature (e.g., the switching temperature), the voltage drop will reach a critical value and signal the control part of the circuit (e.g., transistor 4 as shown in FIG. 1) that there has been an overtemperature condition and the control circuit can then reduce or shut off power to protect the circuit or load and prevent damage. Some key parameters for performance of a PTC overtemperature device include:

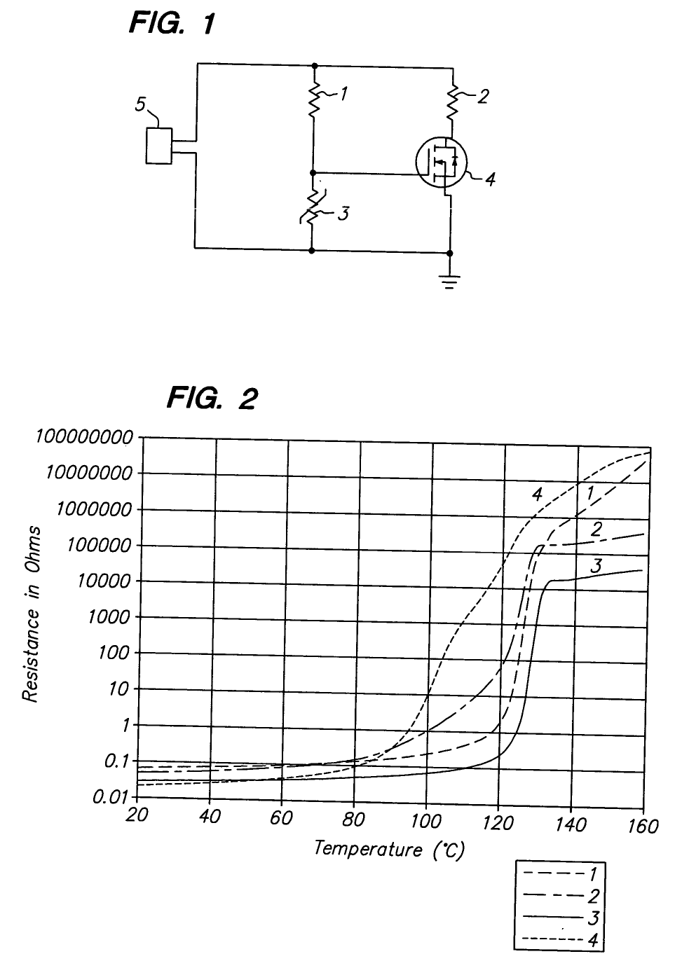

Switching temperature. The switching temperature should be variable for wide applicability across different applications. It can be defined as the temperature at which the device reaches a certain resistance or resistance range. In addition, placement of the part relative to the heat-generating component can cause designers to want to choose devices with different switching temperatures. For example, if the PTC device were to be located flush against the heat generating component, then the designer might want to choose a switching temperature of 110° C., but if it were not mounted flush against the heat generator, but only nearby, the designer might want to choose a lower switching temperature of 100° C. to protect the same circuit against the same fault. The designer will generally want to change the switching temperature independent of the other parameters (see below). Ceramic PTC devices which have been developed show a family of devices having a range of switch temperatures, where the R(T) curves are shifted relative to each other with respect to switching temperature, but do not otherwise significantly change in shape. This is in contrast to what PPTC devices typically demonstrate when their switching temperatures are changed by varying the polymer composition or the conductive filler or the loading as shown in FIG. 2. All devices in FIG. 2 were made as 5 mm×12 mm axial leaded devices. Curve 1 results from a device 0.25 mm (0.010 inch) thick and a formulation comprising approximately 38% by volume carbon black (Raven™ 430, supplied by Columbian Chemicals) in 62% (by volume) high density polyethylene (HDPE) (Petrothene™ LB832 supplied by Equistar); curve 2 results from a device 0.25 mm (0.010 inch) thick and a formulation comprising approximately 38% by volume Raven™ 430 and 62% by volume of a 45%/55% blend of Petrothene™ LB832 and ethylene butyl acrylate copolymer (EBA) (Enathene™ 70509 supplied by Equistar); curve 3 results from a device 0.25 mm (0.010 inch) thick and a formulation comprising approximately 40% by volume Raven™ 430 in 60% by volume Petrothene™ LB832; and curve 4 results from a device 0.125 mm (0.005 inch) thick and a formulation comprising approximately 38% by volume Raven™430 and 62% by volume of a 10/90 HDPE/EBA blend. All devices whose R(T) characteristics are shown in FIG. 2 were crosslinked using 10 Mrad irradiation.

When the polymer component of a conductive composite is changed, or if polymer blends are used, many other aspects of the thermal responsive of the resulting device may change (i.e., the resistance in the tripped state may be lowered, ΔR/ΔT or the entire shape of the resistance/temperature profile may be changed, the resistance at low temperature may be changed, or the device size may have to be changed to account for differences in resistivities resulting from the change in composite composition). Any of these could cause the designer to have to redesign the circuit for the sole purpose of changing the switching temperature of the device, which is not desired. By using beam dose to finely tune the R(T) properties of a polymeric device, it is possible to provide a family of polymeric devices with varying switch temperatures without causing undesired changes in other parameters. For example, many silicon devices will not operate properly when the temperature exceeds 125° C. As shown in FIG. 2, PPTCs made from high density polyethylene (HDPE) have switching temperatures above 125° C., often close to 130° C., so they are not optimized for thermal protection applications at or below 125° C. By using the processes described herein, it is possible to lower the switching temperature of devices made from HDPE while either maintaining or increasing the resistance at the switch temperature.

Switching temperature range for a given device. In general, circuit designers desire the switching temperature range to be as narrow as possible for applications to provide reliable thermal protection while avoiding nuisance faults. That is, the designers desire that the overtemperature protection device never reach its high resistance state under normal operating conditions, out always reach its high resistance state under a fault condition. Sometimes the normal operating condition temperature may be very close to the fault condition temperature (e.g., within 10 degrees). This can be accomplished by either having a high degree of device-to-device reproducibility of R(T) characteristics, or by having a very steep R(T) curve in the range of interest (e.g., at the switching temperature).

Resistance at high temperature. The circuit designer will usually specify a minimum resistance the device must reach at the switching temperature. For many applications using a voltage divider circuit, it will be desired that this resistance is very high (e.g., greater than 50 kohm, or in some cases greater than 1 Mohm) to keep leakage current minimized (for example, resistor 1 as shown in FIG. 1 may be 50 kohm, or greater than 1 Mohm to minimize leakage current). This is especially important for battery driven applications. By using the process described herein, the resistance at high temperature can be increased.

Resistance under normal operating condition. If the PTC device is not to be used as a series element, then a resistance in the normal operating state of 500 to 1000 ohm may be low enough for some applications. However, it is desired to maximize the difference in resistance between the normal and fault conditions, so it is generally desired to keep the resistance in the normal operating state as low as possible, and the resistance in the fault condition as high as possible. If the PTC device is to be used as a series element, then it is clear that a low resistance could be desired to carry proper levels of current continuously. Although the use of an additional high beam dose generally increases the resistance at low temperature (e.g., by approximately a factor of 2) the resistance at high temperature can be increased much faster (e.g., the resistance at high temperature can be increased by more than an order of magnitude while the resistance at low temperature increases by a factor of 2), resulting in a device with greater difference in resistance between the low and high temperature states.

Hysteresis (difference in RT characteristics between heating and cooling). In some applications, after a fault, it is desired that the device cool to a low resistance state at a temperature not very different than the switching temperature upon heating. This will be the most important in applications where the temperature difference between normal operating conditions and fault conditions is small. A decrease in hysteresis has been shown with a 200 Mrad dose (see Example 14). In other applications it is desired that the device cool to a low resistance state at a lower temperature than the switching temperature upon heating. This will be the most important in applications where the circuit is susceptible to cycling.

Cost. This must be kept as low as possible. The beam dose technique allows many thousands of devices to be processed at once, and allows a variety of devices to be prepared from the same starting materials, allowing a reduction of the numbers of types of plaque that must be built and kept in inventory. Processing the panels after they already have been patterned or drilled allows very high beam doses to be used without vacuum steps because the gases, which are by-products of beaming, can easily escape.

The invention is illustrated in the following Examples, in which Examples 1, 5, 6, and 11 are comparative Examples.

### Comparative Example 1 and Examples 2 to 4

A conductive polymer composition was prepared by blending about 60% by volume high density polyethylene (Petrothene™ LB832, available from Equistar) with about 40% by volume carbon black (Raven™ 430, available from Columbian Chemicals), and then extruding the sheet and laminating with nickel foil in a continuous process. The laminated sheet was cut into individual laminates of 0.3×0.41 m (12×16 inch). The laminates were irradiated to 10 Mrad prior to processing. Holes were drilled through the thickness of the individual laminates in a regular pattern to provide one hole for each device. The drilled holes were sensitized and then a layer of copper was electroless plated onto the sensitized surfaces, and a layer of solder was plated onto the copper surface. Using a standard photoresist process, a pattern was etched onto both sides of the individual laminates. The patterned laminate was first separated into strips using a shear or saw, and then the strips were subdivided into individual devices by mechanical snapping. The devices produced had approximate dimensions of 3×2.5×0.5 mm (0.12×0.10×0.020 inch). For Comparative Example 1, no post-processing irradiation (i.e. “post beaming”) was performed. For Examples 2 to 4, post beaming was performed, preceded by a heat treatment which exposed the devices to temperatures above the melt (60 minutes between 150° C. and 160° C. and 40 minutes between 160° and 170° C., followed by cooling to below the melt over a period of 30 minutes). Results are shown in Table 1. The switching temperature is given as the temperature at which the devices reached 1 Mohm. Hysteresis was determined as the difference in temperature between the heating and cooling cycles at which the devices reached 1 Mohm. The PTC anomaly, also referred to as autotherm height (“ATH”), is calculated as log[R(140° C.)/R(20° C.)], using the resistance measurements made at 140° C. and 20° C.

### Comparative Examples 5 to 6 and Examples 7 to 10

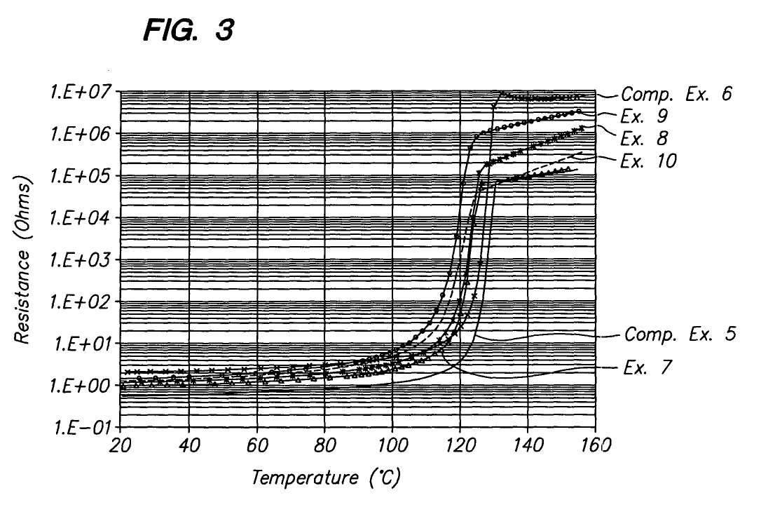

Devices were prepared as in Examples 1 to 4, except the composition contained Mg(OH)₂ (Kisuma 5A, available from Kisuma), and the devices produced had approximate dimensions of 4.6×3×0.25 mm (0.18×0.12×0.010 inch). The laminates were irradiated to 7 Mrad prior to processing, except in the case of Example 10 which was not irradiated prior to processing. For Comparative Examples 5 and 6, no post beaming was performed. For Examples 7 to 10, post beaming was performed as described in Examples 2 to 4. Results are shown in Table 2. The switching temperature is given as the temperature at which the devices reached 10 kohm. R(T) curves for Comparative Examples 5 and 6 and Examples 7 to 10 are shown in FIG. 3, with the curve number corresponding to the respective Example number.

### Comparative Example 11 and Example 12

Devices were prepared as in Examples 1 to 4, except that the polymer used was 45%/55% blend of Petrothene™ LB832 and ethylene butyl acrylate copolymer (EBA) (Enathene™ 70509 supplied by Equistar) and the devices produced had approximate dimensions of 2.0×1.3×0.25 mm (0.08×0.05×0.010 inch) and were singulated by sawing. Results are shown in Table 3. The switching temperature is given as the temperature at which the devices reached 10 kohm.

### Examples 13 and 14

Devices were prepared as in Examples 2 to 4, except that the laminate was irradiated to 10 Mrad prior to processing, and the devices produced had approximate dimensions of 2.0×1.3×0.5 mm (0.08×0.05×0.020 inch) and were singulated by sawing. Results are shown in Table 4. The switching temperature is given as the temperature at which the devices reached 1 Mohm. Hysteresis was determined as the difference in temperature between the heating and cooling cycles at which the devices reached 1 Mohm.

TABLE 1
Comparative Example 1 and Examples 2 to 4

| | Example | | | |
|---|---|---|---|---|
| | 1 (Comp.) | 2 | 3 | 4 |
| HDPE (vol %) | 60 | 60 | 60 | 60 |
| Carbon black (vol %) | 40 | 40 | 40 | 40 |
| Irradiation on laminate | 10 | 10 | 10 | 10 |
| (Mrad) | | | | |
| R (20° C.) (ohm) | 21 | 80 | 100 | 250 |
| R (140° C.) (ohm) | 6 × 10⁶ | 3.3 × 10⁷ | 4 × 10⁷ | 2 × 10⁸ |
| PTC anomaly | 5.45 | 5.6 | 5.6 | 5.9 |
| Switching Temp (° C.) | 128 | 122 | 122 | 115 |
| Post process (Mrad) | 0 | HT/50 | HT/100 | HT/50/HT/50 |
| Hysteresis between | 7 | 7 | 8 | 7 |
| heat & cool (° C.) | | | | |

TABLE 2
Comparative Examples 5 to 6 and Examples 7 to 10

| | Example | | | | | |
|---|---|---|---|---|---|---|
| | 5 | 6 | | | | |
| | (Comp.) | (Comp.) | 7 | 8 | 9 | 10 |
| HDPE | 59 | 56.5 | 59 | 59 | 59 | 59 |
| (vol %) | | | | | | |
| Carbon | 36 | 28.5 | 36 | 36 | 36 | 36 |
| Black | | | | | | |
| (vol %) | | | | | | |
| Mg(OH)₂ | 5 | 15 | 5 | 5 | 5 | 5 |
| (vol %) | | | | | | |
| Irradiation | 7 | 7 | 7 | 7 | 7 | 0 |
| on laminate | | | | | | |
| (Mrad) | | | | | | |
| R (20° C.) | 0.59 | 2.19 | 1.03 | 1.22 | 1.53 | 1.4 |
| (ohm) | | | | | | |
| R (140° C.) | 8.9 × 10⁴ | 6.4 × 10⁶ | 9.4 × 10⁴ | 4.2 × 10⁵ | 1.9 × 10⁶ | 1.2 × 10⁵ |
| (ohm) | | | | | | |
| PTC | 5.2 | 6.5 | 5 | 5.5 | 6.1 | 4.9 |
| anomaly | | | | | | |
| Switching | 128.5 | 127 | 124.2 | 123.5 | 119.5 | 122 |
| Temp (° C.) | | | | | | |
| Post process | 0 | 0 | 50 | HT/50 | HT/50/HT/50 | HT/50/HT/50 |
| (Mrad) | | | | | | |

TABLE 3
Comparative Example 11 and Example 12

| | Example | |
|---|---|---|
| | 11 (Comparative) | 12 |
| 45/55 blend of HDPE/EBA (vol %) | 62 | 62 |
| Carbon Black (vol %) | 38 | 38 |
| Irradiation on laminate (Mrad) | 10 | 10 |
| R (20° C.) (ohm) | 4.5 | 9 |
| R (140° C.) (ohm) | 4 × 10⁴ | 2 × 10⁷ |
| PTC anomaly | 3.95 | 6.35 |
| Switching Temperature (° C.) | 129.7 | 104.5 |
| Post process (Mrad) | 0 | HT/50/HT/50 |

TABLE 4
Examples 13 and 14

| | Example | |
|---|---|---|
| | 13 | 14 |
| HDPE (vol %) | 60 | 60 |
| Carbon Black (vol %) | 40 | 40 |
| Irradiation on laminate (Mrad) | 10 | 10 |
| R (20° C.) (ohm) | 80 | 80 |
| R (140° C.) (ohm) | 1 × 10⁸ | 1.7 × 10⁸ |
| PTC anomaly | 6.1 | 6.3 |
| Switching Temperature (° C.) | 119 | 118.4 |
| Post process (Mrad) | HT/50/HT/50 | HT/100/HT/100 |
| Hysteresis between heat and cool | 8 | 4.8 |
| (° C.) | | |

It will be understood that the above-described arrangements of apparatus and the methods therefrom are merely illustrative of applications of the principles or this invention and many other embodiments and modifications may be made without departing from the spirit and scope of the invention as defined in the claims.

What is claimed is:

1. A method for tuning a resistance v. temperature profile of a surface mountable polymeric PTC device for use as an overtemperature protection device, said method comprising:
(a) preparing a laminate comprising a conductive polymer composite sandwiched between metal foil electrodes, said polymer composite having a melting temperature Tₘ;
(b) crosslinking the laminate;
(c) forming a panel from the crosslinked laminate by patterning the laminate to form a plurality of surface mountable devices;
(d) irradiating the panel using electron beam irradiation of at least 20 Mrad; and
(e) providing individual devices by subdividing the irradiated panel.

2. A method according to claim 1, wherein the crosslinking of the laminate is accomplished using irradiation.

3. A method according to claim 2, wherein the panel is irradiated using electron beam irradiation of at least 50 Mrad.

4. A method according to claim 1 wherein the panel is subjected to a heat treatment comprising a temperature exceeding the melting temperature of the conductive polymer composite prior to the irradiation of the panel.

5. A method according to claim 2 wherein the panel is subjected to a heat treatment comprising a temperature exceeding the melting temperature of the conductive polymer composite prior to the irradiation of the panel.

6. A method according to claim 1, wherein the irradiation of the panel is accomplished using more than one irradiation step to achieve the electron beam irradiation of at least 20 Mrad, and the panel is subjected to a heat treatment comprising a temperature exceeding the melting temperature of the composite before each irradiation step.

7. A method for tuning a resistance v. temperature profile of a polymeric PTC device for use as an overtemperature protection device, said method comprising:
(a) preparing a laminate comprising a conductive polymer composite sandwiched between metal foil electrodes, said polymer composite having a melting temperature Tₘ;
(b) crosslinking the laminate;
(c) forming individual devices from the crosslinked laminate; and
(d) irradiating the individual devices using electron beam irradiation of at least 20 Mrad.

8. A method according to claim 7, wherein the individual devices are surface mountable.

9. A method according to claim 7, wherein the crosslinking of the laminate is accomplished using irradiation.

10. A method according to claim 7, wherein the individual devices are irradiated using electron beam irradiation of at least 50 Mrad.

11. A method according to claim 7, wherein the individual devices are subjected to a heat treatment comprising a temperature exceeding the melting temperature of the polymer composite prior to irradiation.

12. A method according to claim 7, wherein the irradiation is accomplished using more than one irradiation step, and a heat treatment comprising a temperature exceeding the melt temperature of the polymer composite is performed prior to each irradiation step.
